(19) United States
(12) Patent Application Publication
(10) Pub. No.: US 2017/0240456 A1
(43) Pub. Date: Aug. 24, 2017

(54) METHODS AND SYSTEMS FOR PROCESSING OPTICAL FIBERS

(71) Applicant: Corning Incorporated, Corning, NY (US)

(72) Inventors: Ravindra Kumar Akarapu, Painted Post, NY (US); Ming-Jun Li, Horseheads, NY (US); Anping Liu, Horseheads, NY (US); Barada Kanta Nayak, Painted Post, NY (US); Bruce Warren Reding, Wilmington, NC (US)

(21) Appl. No.: 15/432,404

(22) Filed: Feb. 14, 2017

Related U.S. Application Data
(60) Provisional application No. 62/299,055, filed on Feb. 24, 2016.

(51) Int. Cl. C03B 37/12; C03B 37/025; G02B 6/02

(52) U.S. Cl. CPC C03B 37/12; G02B 6/02; C03B 37/025; G02B 5/10

(57) ABSTRACT

A method and corresponding apparatus for processing optical fiber include directing light from a directed light source toward an optical fiber on a fiber draw. A fiber core of the optical fiber is heated, using at least the light from the directed light source, to a fiber core temperature within a glass transformation temperature range of the fiber core. The method can be used to reduce fictive temperature of the fiber core, with Rayleigh scattering being reduced, leading to lower attenuation losses in the fiber core.

This application claims the benefit of priority under 35 U.S.C. §119 of U.S. Provisional Application Ser. No. 62/299,055 filed on Feb. 24, 2016 the content of which is relied upon and incorporated herein by reference in its entirety.

### BACKGROUND

Optical fiber can be manufactured by drawing a solid glass fiber preform through a vertical fiber drawing system, or “draw.” An end of the fiber preform can be heated above the glass melting point by a furnace, allowing an optical fiber to be drawn out of the preform. Fibers can subsequently pass through other processing steps, such as furnace-based fiber curing.

### SUMMARY

One of the challenges in drawing optical fiber is that the glass matrix rapidly cools after forming. This results in a limited envelope of time in which subsequent process steps that require the glass to be above a certain temperature can be performed. In particular, it is beneficial to control cooling of an optical fiber to a rate that is slower than that of cooling in ambient, room temperature air to reduce non-bridging oxygen (NBO) and other anomalies in the fiber core. Fictive temperature of the fiber core can also be reduced with slower cooling rates, which can reduce the Rayleigh scattering related attenuation of optical signals in the finished optical fiber. Furthermore, it may be desirable to operate a fiber draw at high speeds, such as above 20 meters of fiber per second (m/s) or above 30 m/s or 40 m/s. Higher speeds of fiber drawing result in even greater limitations on the space (fiber length) within which processing steps must occur.

Embodiments of the present disclosure permit an optical fiber on a fiber draw to be reheated rapidly, within very short fiber lengths, even at high draw speeds. Fiber core temperatures can be raised to a glass transformation temperature range of the fiber core, and subsequent cooling can be controlled according to a variety of temperature versus time/fiber position profiles as necessary to reduce defects, decrease attenuation, and perform other processing steps on the fiber draw.

In one aspect, a method of processing optical fiber includes directing light from a directed light source toward an optical fiber on a fiber draw. The method may further include heating a fiber core of the optical fiber, using at least the light from the directed light source, to a fiber core temperature within a glass transformation temperature range of the fiber core. Heating the fiber core can include irradiating the optical fiber radially non-symmetrically with the light or using a furnace after directing light from the directed light source. As used herein, “light” refers to any wavelength for which emission is practical and has non-negligible absorption by the glass.

Heating the fiber core can be performed without melting the fiber core or a fiber cladding around the fiber core. Heating the fiber core can include maintaining a transient fiber cladding temperature to within 500° C., 400° C., 300° C., 200° C., or 100° C. of a transient fiber core temperature. Heating the fiber core can include reheating the drawn fiber before allowing the fiber core to cool below 200° C., 400° C., 600° C., 800° C., or 1000° C.

The method may include controlling cooling so that the fiber core cools more slowly to reduce fictive temperature or non-bridging oxygen in the fiber core relative to cooling using room temperature air. Controlling cooling may include using a vacuum, furnace, or additional directed light source to reduce a cooling rate of the fiber core. The method may also include heating a fiber cladding of the optical fiber to a temperature substantially equal to the fiber core temperature.

Directing the light toward the optical fiber may include introducing the light into a hollow waveguide through which the optical fiber is drawn. The hollow waveguide may have a non-circular or polygonal interior high-reflectivity surface. Directing the light may also include beam expanding the light to an aspect ratio greater than or equal to 20, actively scanning a beam of the light along an axis of the optical fiber, beam splitting the light into a plurality of split beams and simultaneously beam expanding the split beams to intersect a plurality of respective segments of the optical fiber, or reflecting the light using a parabolic reflector, where the optical fiber is drawn through a focal line of the parabolic reflector. Directing the light and heating the fiber core may also be performed with the fiber draw operating at a speed greater than or equal to 10 meters of fiber per second (m/s) or with the fiber draw operating at a speed greater than or equal to 20 m/s or 30 m/s. Directing the light may further include illuminating with the light, at any given time, a length of the optical fiber less than or equal to about 1 meter (m). Directing the light may also include illuminating with the light, at any given time, a length of the optical fiber greater than or equal to 1 centimeter (cm). Directing the light can include using an LED, CO₂ laser, CO laser, quantum cascade (QC) laser, pulsed laser, continuous wave (cw) laser, or ultraviolet (UV) light source for the directed light source, and an optical depth of the directed light source may be small in relation to a radius of the optical fiber.

Directing light from the directed light source can include using a light wavelength for which an absorption depth of the optical fiber is greater than about 10 microns and less than or equal to about the diameter of the optical fiber without an outer coating. Directing light toward the optical fiber can include causing the light to intersect the optical fiber from more than one radial direction around the fiber. Directing the light can include using a pulsed directed light source or a high-aspect ratio light beam.

In another aspect, a system for processing optical fiber includes a light-based optical fiber heater, the heater including (i) a direct light source and (ii) a light director configured to direct light from the light source to an optical fiber on a fiber draw. The fiber heater may be configured to heat a fiber core of the optical fiber to a fiber core temperature within a glass transformation temperature range of the fiber core.

The light-based optical fiber heater may be further configured to control cooling so that the fiber core cools more slowly to reduce fictive temperature, Rayleigh scattering, or non-bridging oxygen in the fiber core relative to cooling in room temperature air, and the system may include a vacuum system, furnace, or additional directed light source to control cooling by reducing a cooling rate of the fiber core.

The light-based optical fiber heater can be further configured to heat the fiber core without melting the fiber core or the fiber cladding around the fiber core. The light-based optical fiber heater can be further configured to maintain a transient fiber cladding temperature to within 500° C., 400° C., 300° C., 200° C., or 100° C. of a transient fiber core temperature.

The light director may include a hollow waveguide through which the optical fiber is drawn, and the hollow waveguide may have a non-circular, polygonal, or elliptical interior surface. The light director may also include a beam expander configured to expand a beam of the light to an aspect ratio greater than or equal to 20, an active scanner configured to scan the beam of the light along an azimuth (z axis) of the optical fiber, a plurality of beam splitters configured to provide a plurality of split beams and a plurality of respective beam expanders configured to simultaneously cause the respective split beams to intersect the optical fiber at a plurality of respective segments of the optical fiber, or a parabolic reflector configured to focus the light toward a focal line of the parabolic reflector through which the optical fiber is drawn. The light director may be configured to direct the light, at any given time, over a length of the optical fiber less than or equal to about 1 meter. The light director may also be configured to direct the light, at any given time, over a length of the optical fiber greater than or equal to 1 centimeter (cm). The light director can be further configured to cause the light to intersect the optical fiber from more than one radial direction around the fiber. The light director can also be configured to direct light in the form of a high aspect ratio light beam. The high aspect ratio can be greater than or equal to 20 or 100.

The light-based optical fiber heater may include a furnace configured to heat the fiber core of the optical fiber, and the light-based fiber heater may be configured to irradiate the optical fiber radially non-symmetrically or radially symmetrically with the light. The heater may be configured to heat the fiber core with the fiber draw operating at a speed greater than or equal to 10 m/s or greater than or equal to 20 m/s (e.g., >30 m/s or >40 m/s). The light-based optical fiber heater can also be configured to reheat the drawn fiber before allowing the fiber core to cool to below 200° C., 400° C., 600° C., 800° C., or 1000° C.

The directed light source may include an LED, CO₂ laser, CO laser, quantum cascade (QC) laser, pulsed laser, continuous wave (cw) laser, or ultraviolet (UV) light source, and the directed light source may be configured to output light with a wavelength having an optical depth that is small in relation to a radius of the optical fiber. Such an optical depth can ensure that more of the light from the directed light source that refracts into the fiber is absorbed, thereby delivering a greater percentage of the light's energy to the fiber. As will be described hereinafter, there are also potential advantages to using light with a wavelength for which the optical depth is of the same order as or larger than the radius of the fiber. The directed light source can also include various optical components such as mirrors, lenses, etc. to condition, shape, steer, or otherwise direct the light. The directed light source can be configured to output a light wavelength for which an absorption depth of the optical fiber is greater than about 10 microns and less than or equal to about the uncoated fiber diameter. (Note that, for standard optical fiber used for communications, this diameter would be 125 microns.) The directed light source can be a pulsed directed light source.

In yet another aspect, a system for processing optical fiber includes means for directing light from a directed light source toward an optical fiber on a fiber draw and means for heating a fiber core of the optical fiber, using at least the light from the directed light source, to a fiber core temperature within a glass transformation temperature range of the fiber core.

### BRIEF DESCRIPTION OF THE DRAWINGS

The foregoing will be apparent from the following more particular description of example embodiments of the disclosure, as illustrated in the accompanying drawings in which like reference characters refer to the same parts throughout the different views. The drawings are not necessarily to scale, emphasis instead being placed upon illustrating embodiments of the present disclosure.

FIG. 1A is a block diagram illustrating a light-based optical fiber heater.

FIG. 1B is a graph illustrating enthalpy of a glass optical fiber core as a function of temperature.

FIG. 2A is a schematic diagram of a fiber draw with fluid fiber turning devices.

FIG. 2B is a graph illustrating calculated rise in temperature of a 1 meter length of optical fiber with different axisymmetric heat fluxes.

FIG. 3A is an illustration of an embodiment of a light-based optical fiber heater including a high-power CO₂ laser.

FIG. 3B is a schematic illustration of a cross section of a high-aspect-ratio light beam.

FIGS. 4A-4C illustrate calculated temperature variation over a cross-section of optical fiber using directed light of various wavelengths of directed light illuminating the fiber from a single axial direction.

FIG. 5A is a schematic illustration of illuminating an optical fiber from four different axial directions.

FIGS. 5B-5D are temperature diagrams similar to those in FIGS. 4A-4C, respectively based on the illumination of the optical fiber from four directions, as illustrated in FIG. 5A.

FIG. 6A is a graph showing cladding and core temperatures for an optical fiber when heating from the four directions illustrated in FIG. 5A, with the heating occurring at time intervals.

FIGS. 6B and 6C are temperature diagrams illustrating fiber cross-sectional temperatures at various times for the heating conditions illustrated in FIG. 6A.

FIG. 7A is a schematic diagram of a light-based optical fiber heater including fixed beam splitters and high-aspect-ratio beam-shaping lenses.

FIG. 7B is a schematic diagram of a light-based optical fiber heater including rotatable beam splitters.

FIG. 7C is a schematic diagram of a light-based optical fiber heater including both rotatable, scanning beam splitters and a parabolic mirror.

FIG. 7D is a cross-sectional schematic diagram of the parabolic mirror and optical fiber illustrated in FIG. 7C.

FIG. 7E includes graphs showing various temperature profiles that can be achieved using the embodiments systems illustrated in FIGS. 7A-7D.

FIGS. 8A-8G illustrate various hollow waveguides that can form part of a light-based optical fiber heater.

FIGS. 9A-9C are flow diagrams illustrating embodiment methods.

FIG. 10 is a graph illustrating surface and core temperatures as a function of distance along the fiber and as a function of illumination.

### DETAILED DESCRIPTION

A description of example embodiments of the disclosure follows.

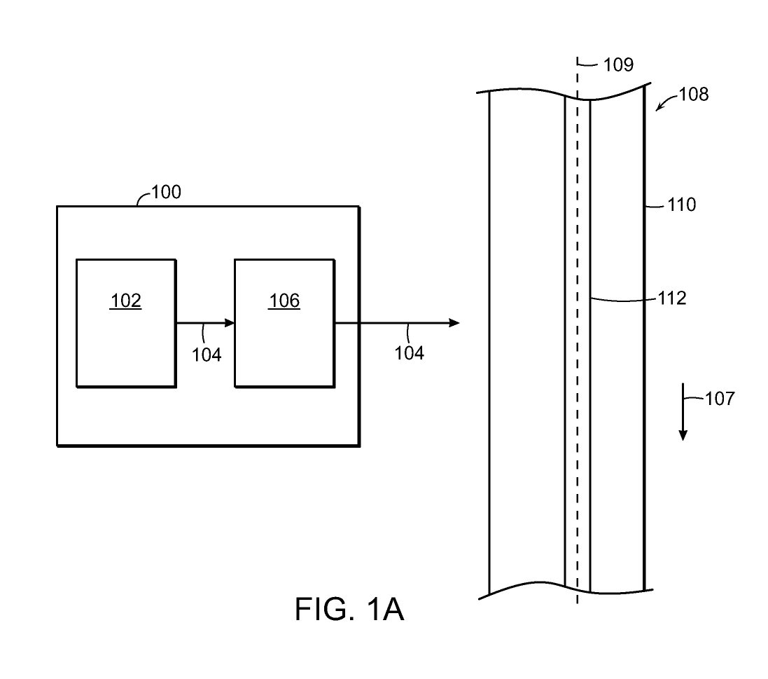

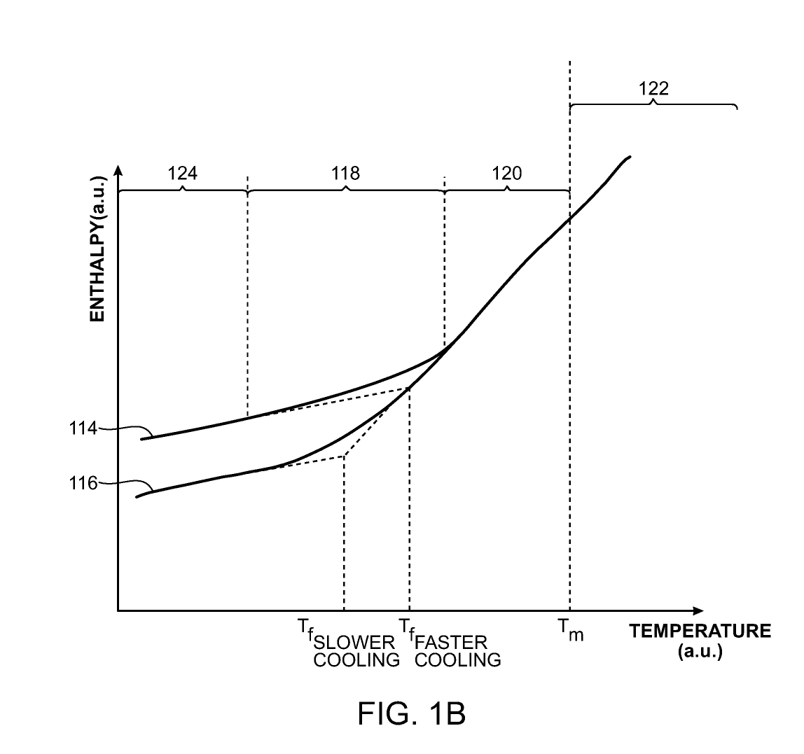

FIG. 1A illustrates a light-based optical fiber heater 100, which includes a directed light source 102 and a light director 106. As used herein, “light” refers to any wavelength that has practical emission for the disclosed applications and for which absorption in optical fiber glass is non-negligible. The directed light source 102 outputs directed light 104. The directed light source 102 can include, for example, a light emitting diode (LED), CO₂ laser, CO laser, quantum cascade (QC) laser, pulsed laser, continuous wave laser, or ultraviolet light source. A “directed light source,” as used herein, has sufficiently limited divergence that the light can be aimed at optics that steer, shape, focus, or otherwise process the light, or can be aimed at an optical fiber. In some embodiments, for example, the directed light source 102 includes a multi-kilowatt CO₂ laser. Furthermore, the directed light source 102 can include other high-brightness light sources operating in ranges of wavelengths that can be absorbed by an optical fiber. Preferably, the light 104 has a wavelength in the range of about 3.5 microns (μm) to about 11 microns. However, the light can also be provided over a wider wavelength range between, for example, about 2 microns and about 16 microns. Furthermore, silica optical fiber absorbs in the ultraviolet, and in some embodiments, an ultraviolet light source is used for directed light.

In some embodiments, a wavelength of the light 104 output by the directed light source 102 is such that the optical depth of the light for an optical fiber is small relative to the radius of the optical fiber. Such an optical depth ensures that more of the light from the directed light source that refracts though the fiber is absorbed, thereby delivering a greater percentage of its energy to the fiber. This characteristic can enable essentially all of the light from the directed light source that is refracted into the fiber to be absorbed by the fiber, thereby delivering essentially all of the light's energy. In other embodiments, a wavelength of the light 104 output by the directed light source 102 is such that the optical depth of the light is of the same order as or larger than the radius of the fiber. This characteristic can enable uniform internal temperature, as described hereinafter.

The light director 106 directs the light 104 from the light source to an optical fiber 108 on a fiber draw. “Directing light,” as used herein, includes processing the light by steering, shaping, scanning, focusing, defocusing, or otherwise manipulating light from the directed light source to cause the directed light to be incident at an optical fiber. The optical fiber includes an outer fiber cladding 110 and an inner fiber core 112 and is drawn in a draw direction 107 indicated in FIG. 1A along an axis 109 of the optical fiber 108. The fiber heater 100 is configured to heat the fiber core 112 of the optical fiber 108 to a fiber core temperature within a glass transformation temperature range of the fiber core, as further described hereinafter with FIG. 1B. By rapidly heating the fiber core temperature to the glass transformation temperature range, followed by subsequent control of the fiber core temperature over time, fictive temperature of the fiber core can be reduced, as well as non-bridging oxygen defects in the fiber core, relative to cooling using only room temperature air. As a consequence, Rayleigh scattering from the fiber core may also be reduced.

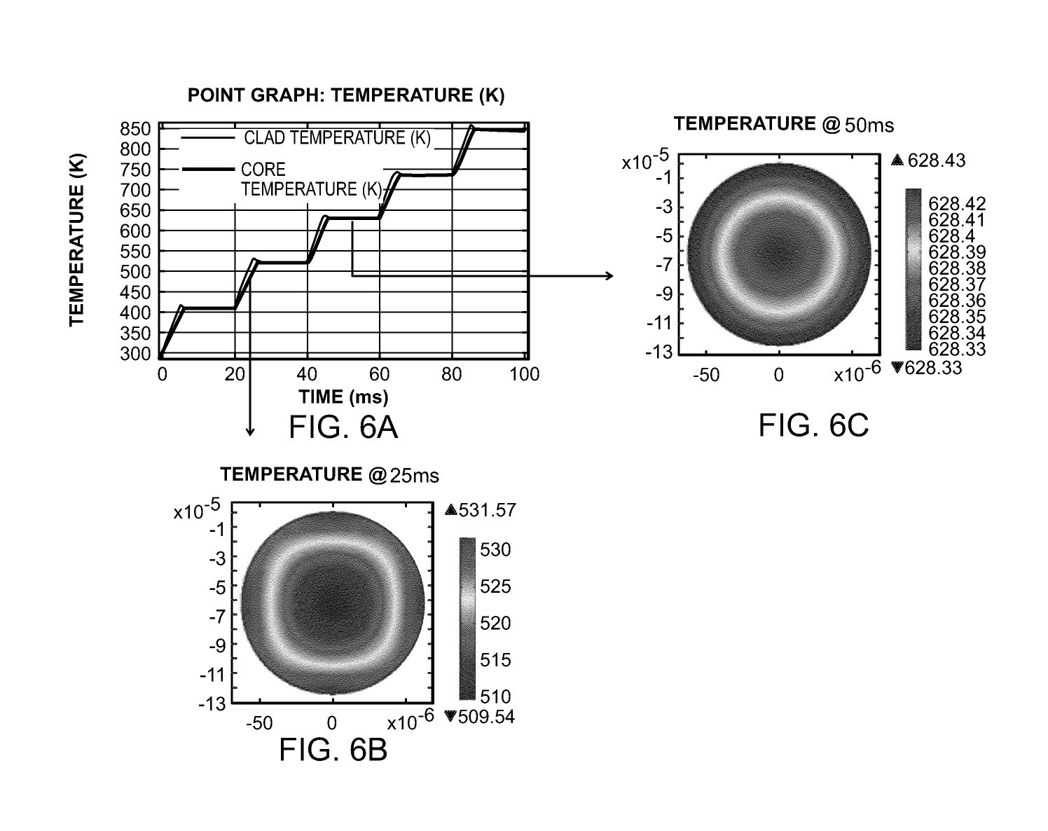

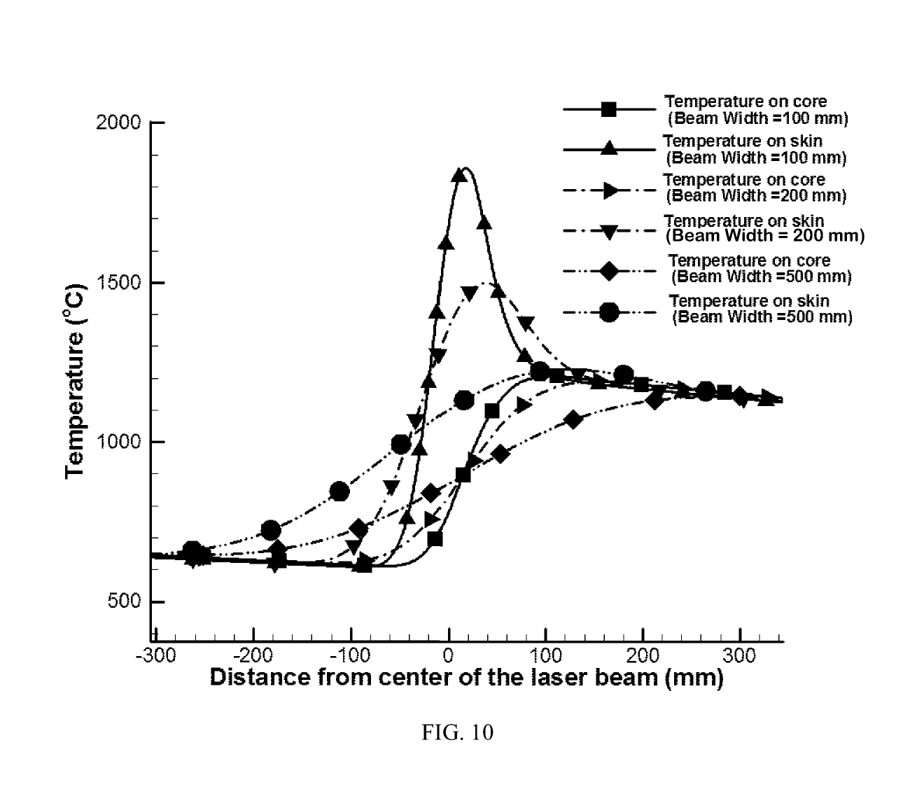

In the process of heating the fiber core 112, the fiber cladding 110 is also heated to some degree. Under some conditions, as described further in conjunction with FIGS. 6A-6C, temperature of the fiber cladding 110 may be substantially equal to temperature of the fiber core 112. In other cases, particularly during periods of heating rapidly using the light-based optical fiber heater, or during periods of rapid cooling, temperatures of the fiber core and cladding may differ by as much as 300° C. or more. For situations in which the surface of the cladding is momentarily higher than the surface of the core, it is desirable that the surface not be momentarily heated to above the melting point of the glass. Methods for avoiding this will be more fully described in reference to FIG. 10.

The light director 106 illustrated in FIG. 1A can include a mirror, a beam splitter, a scanning mirror, a flat mirror, curved mirror, parabolic mirror, beam shaping element (e.g., lens), hollow waveguide, as further described hereinafter, or any combination thereof. Furthermore, in some embodiments illustrated hereinafter, the light director 106 includes multiple lenses, mirrors, or other light directing or beam-shaping elements.

FIG. 1B is a graph illustrating enthalpy of glass, in arbitrary units (a.u.), as a function of temperature (a.u.), illustrating what happens as glass cools. Further, since glass volume behaves in a manner similar to enthalpy, the graph can further be understood to represent glass volume as a function of temperature. FIG. 1B illustrates a glass transformation temperature range 118 over which properties of a glass fiber core vary between those of a supercooled liquid and those of a solid. As the fiber core 112 is cooled below the liquid temperature range 122, once the temperature drops below a crystal melting temperature T_{M}, the fiber core enters a supercooled liquid temperature range 120.

Once in the glass transformation temperature range 118, cooling rate of the glass affects the enthalpy and volume of the solid glass that is eventually formed as the glass cools to a solid temperature range 124. For example, as illustrated in FIG. 1B, a glass fiber core cooled relatively faster along a temperature profile curve 114 has higher enthalpy and volume and is characterized by a relatively higher fictive temperature T_{Ffast cooling}. On the other hand, a glass fiber core that is cooled relatively slower along the temperature profile curve 116, for example, has relatively lower enthalpy and volume and is characterized by a lower fictive temperature T_{Fslow cooling}. Fictive temperature can also be referred to as transition temperature and is defined by the intersection between straight lines representing the cooling curves for the glassy (solid) state and for the supercooled liquid state.

The reduction of fictive temperature of a glass fiber core, as illustrated in FIG. 1B, is only one of the beneficial effects of controlling cooling within the glass transformation range of the fiber core. Non-bridging oxygen (NBO) defects can be reduced by controlling the rate of cooling within the glass transformation range, and attenuation of light in the optical fiber core 112 when carrying optical signals can also be reduced in this manner.

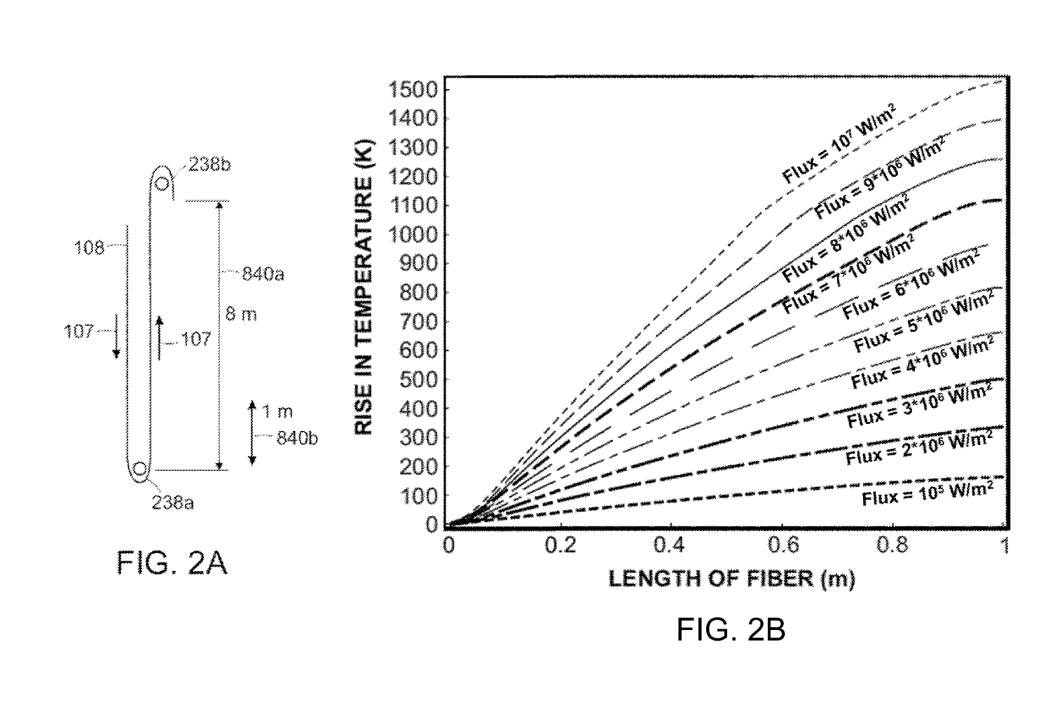

FIG. 2A is a schematic diagram of a fiber draw with fluid fiber turning devices 238a-b. After the first fluid fiber turning device, 238a, the optical fiber 108 will cool down to between 200° C. and 800° C. depending on whether the fiber is being drawn at 10 m/s, or 60 m/s. If the fiber were to be drawn at a speed greater than about 50 meters per second (m/s), a high fictive temperature and considerable residual stresses could be set up in the fiber due to limited span length 840a from the bottom of the fiber draw furnace to the fluid fiber turning device 238a. It is helpful to relieve these stresses to attain required product attributes. With proper heating and cooling between fluid fiber turning devices 238a and 238b, for example, the residual stresses can be relieved. With a span 840a of about 8 m between the fluid fiber turning device 238a and the bottom of the draw furnace, it is necessary to reheat the moving optical fiber 108 to about annealing temperature (within the glass transformation temperature range of the fiber core 112; an increase of temperature of about 700° C.) within a shorter fiber span 840b of about 1 m, and use the longer span 840a between the fluid fiber turning device 238a and 238b to slowly cool the fiber. An example annealing point can be 1215° C. for silica fiber core, while the strain point can be 1120° C. For Germanium (Ge) doped fiber core, the annealing and strain temperature can be slightly lower. Where a fiber core is at 800° C. before reheating, an increase of 700° C. will bring the temperature to about 1500° C.

Using embodiment methods and devices disclosed herein, this reheating of the fiber core of an optical fiber on a fiber draw can be performed without melting the fiber core or a fiber cladding around the fiber core. Note that in other embodiments, distances between fluid fiber turning devices may be different, and specific requirements for span of fiber over which the fiber must be heated can differ from one meter. However, practical lengths of heating apparatus are often limited, and as fiber draw speed increases, the time during which a fiber is present in any heating region becomes smaller.

The exact position at which reheating occurs along the fiber distance between the fluid fiber turning devices 238a and 238b can be used to change the lowest temperature that a fiber core is allowed to reach on the fiber draw before reheating. As described above, in certain embodiments, reheating the drawn fiber can occur before allowing the fiber core to cool to below 200° C. or 800° C. However, in other example embodiments, reheating can occur before allowing the fiber core to cool to below 400° C., 600° C., or 1000° C., for example.

FIG. 2B is a graph illustrating calculated rise in temperature of an optical fiber over a 1 m length, with different axi-symmetric heat fluxes given in units of watts per square meter (W/m²). As illustrated in the graph, a constant axi-symmetric heat flux greater than about 6.5 megawatts per square meter (MW/m²) is needed to raise the temperature of the fiber by 1000° C. within the 1 m fiber span 840b.

While thermal radiation from hot enclosures could be used to reheat fiber, several disadvantages of using hot enclosures alone can be deduced from the graph in FIG. 2B. Silica, of which an optical fiber is made, absorbs radiation only in the mid- to far-infrared (3.5 microns to 430 microns) and deep UV spectral regions. A 3000° C. hot tube surrounding the fiber for a length of 1 m, for example, could raise the temperature of the fiber moving at 30 m/s by only about 100° C., even under the assumption that all infrared radiation in a wavelength range from 3.5 microns to 430 microns is completely absorbed. Thus, using a hot enclosure alone to reheat fiber on a draw to a glass transformation temperature range would require excessive heater lengths and be impractical, especially at higher draw speeds. This indicates that relatively focused, or high energy density, radiation is more suitable for rapid reheating of a fiber on a draw. It is not necessary for the directed light source to be monochromatic or to be a laser. For example, in some embodiments, an LED or other light source can be used. However, it is preferable that emitted radiation be confined to the absorption region of the fiber for greatest absorption efficiency. Furthermore, lasers are a convenient source of directed light. Substantially monochromatic, highly absorbing radiation such as that from a CO₂ laser has the benefit of having well defined, nearly monochromatic light output, with the directionality of the light easily controllable.

Notwithstanding the disadvantages of reheating solely with thermal radiation from a hot enclosure for reasonable draw speeds, such heating with hot enclosures can be used advantageously to bring the fiber to a very precise final temperature after most of the reheating is accomplished using the directed energy source.

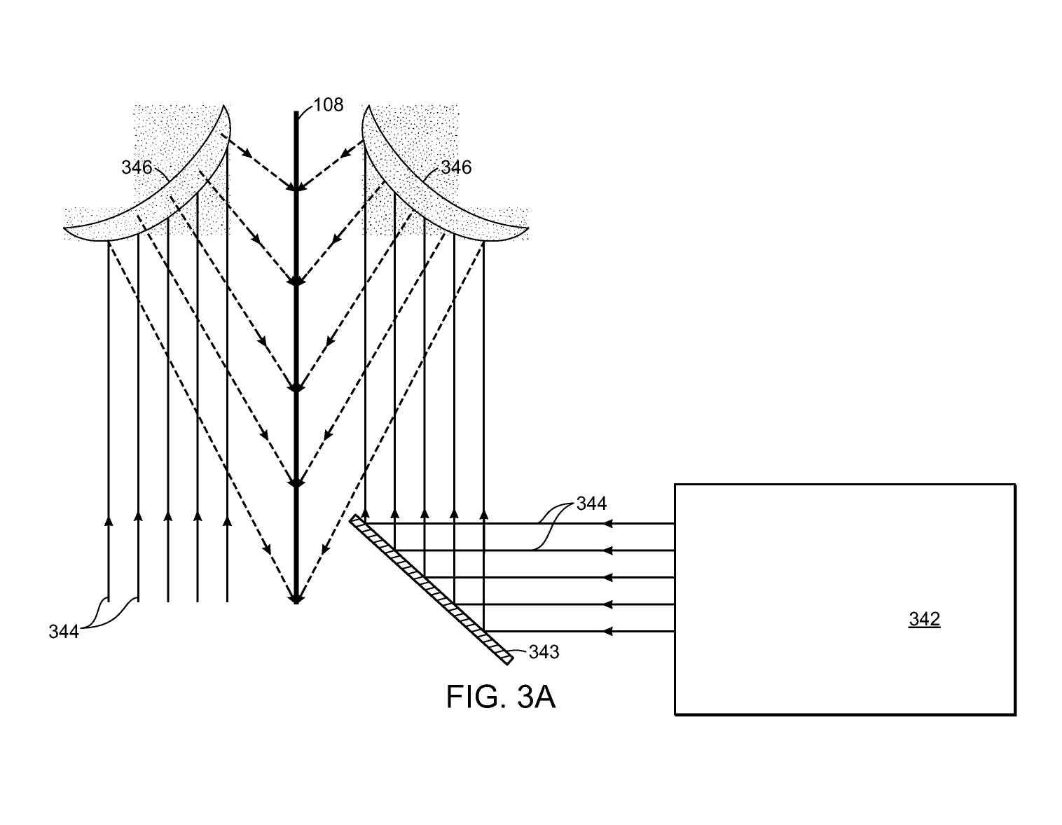

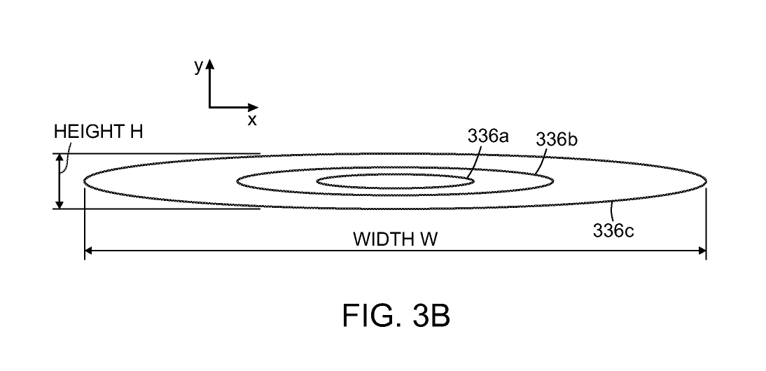

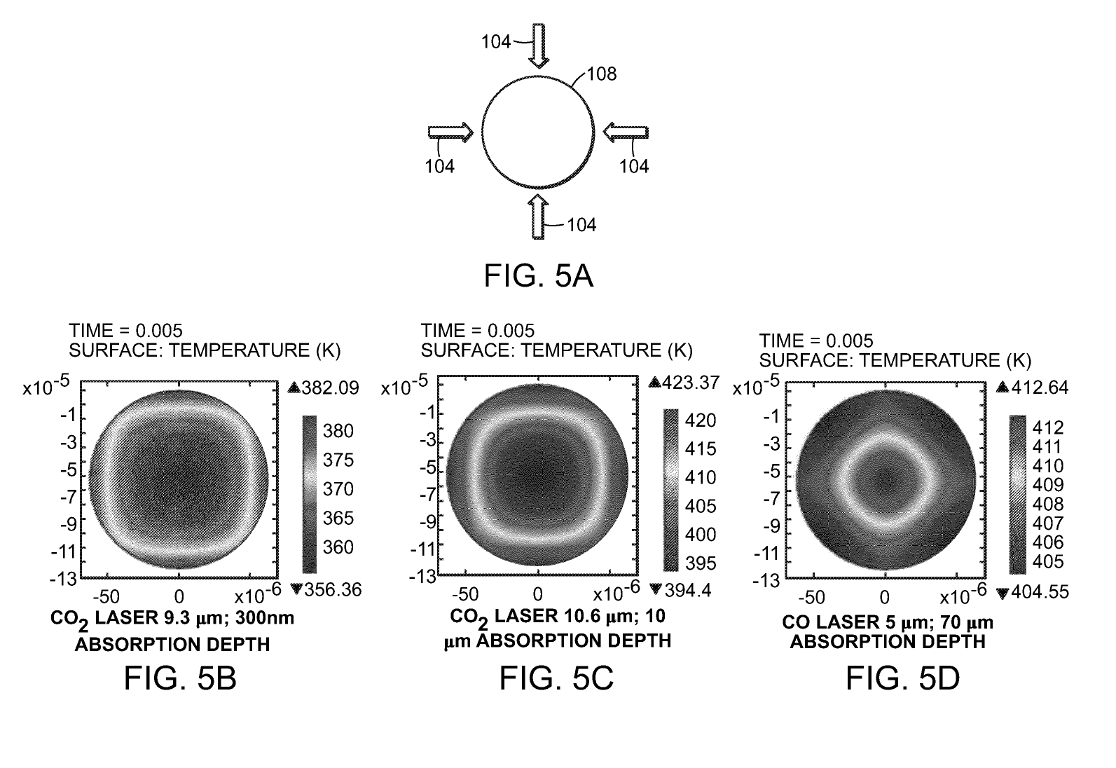

FIG. 3A illustrates a light-based optical fiber heater that includes a high-power CO₂ laser 342 that serves as a directed light source. The laser 342 enables reheating of the moving, on-the-draw fiber 108. A light director includes a mirror 343 configured to reflect light rays 344 from the laser 342 toward a curved parabolic-shaped optical mirror 346, which also forms part of the light director. The parabolic-shaped mirror 346 directs the light rays 344, from a laser beam about 3-4 mm wide, toward the fiber 108. The mirrors 346 direct the light rays 344 to form a nearly line-shaped beam at the fiber 108. While not shown in FIG. 3A, a mirror similar to the mirror 343 can be likewise provided on the left side of the fiber 108 to direct the rays 344 toward the parabolic mirror 346 on the left side. The rays 344 on the left side can be provided by an additional laser (not shown) or by the same laser 342 with appropriate beam splitting. Heating from two sides of the optical fiber 108 increases heating uniformity, a benefit further described hereinafter in conjunction with FIGS. 5A-5D.

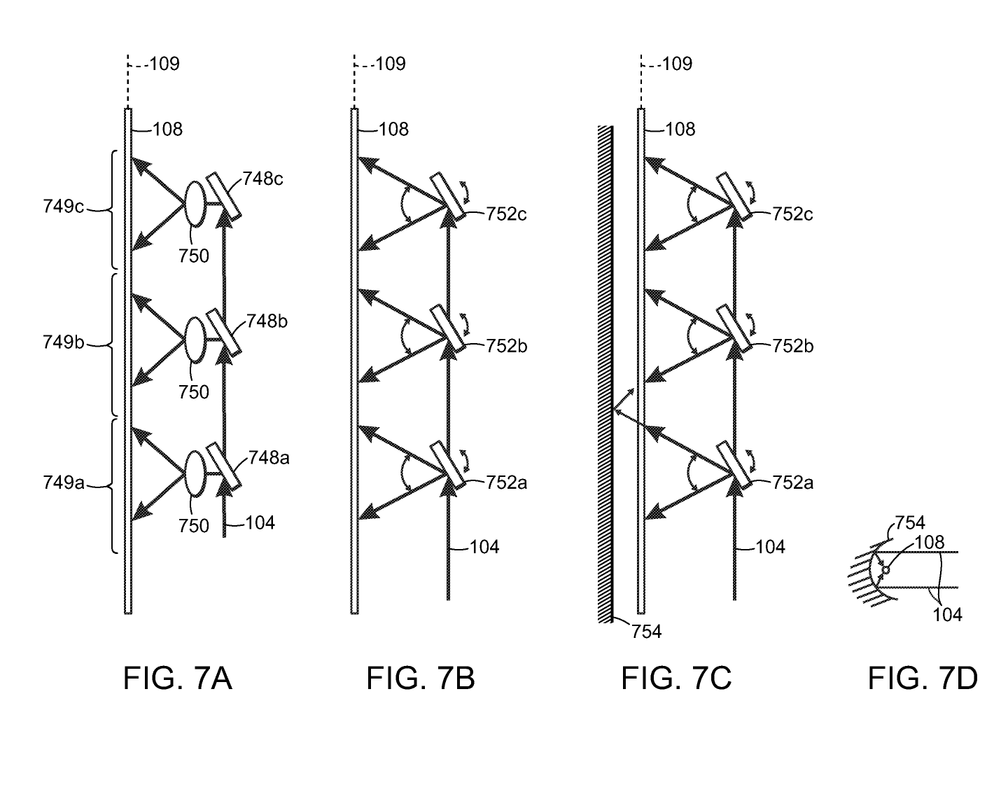

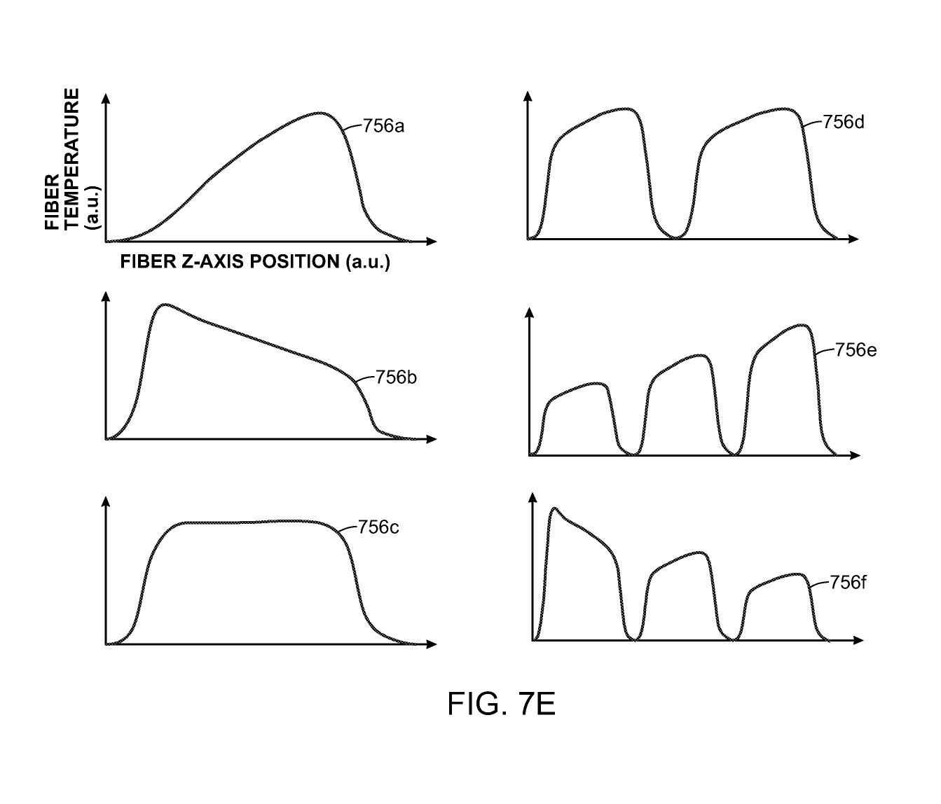

The line-shaped beam for the embodiment of FIG. 3A has an aspect ratio greater than or equal to 100. In other embodiments, beam aspect ratios can be lower, such as greater than or equal to about 20. The aspect ratio can be determined by the required temperature profile. A beam with a large aspect ratio is suitable for relatively uniform profiles such as illustrated in FIG. 7E, for example, in which one beam can meet the temperature profile requirements. For complex temperature profiles, such as profiles 756d-f in FIG. 7E, multiple beams can be useful. In this case, multiple beams with small aspect ratios can be combined to achieve the profiles. In the embodiment of FIG. 3A, the irradiated length of fiber 108 is about 1 m, and an aspect ratio greater than or equal to about 100 provides a minimum preferred beam overlap with the fiber. Furthermore, the aspect ratio is preferably at least 1000, and even more preferably, greater than 5000. For example, for a conventional fiber with a diameter of 125 microns, the beam height, as further illustrated in FIG. 3B, should be only slightly greater than the fiber diameter for best overlap, such as around 200 microns. The beam width is at least 20 mm, preferably at least 200 mm, and even more preferably, at least 1 m. In other embodiments, the beam width can be less than or equal to 1 m, such that the light beam illuminates a length of the optical fiber that is less than or equal to about 1 m at any given time, even in the absence of beam scanning. In some embodiments, the beam width can be greater than or equal to 1 cm, such that the light beam illuminates a length of the optical fiber that is greater than or equal to 1 cm at any given time, even in the absence of beam scanning. This minimum beam width can facilitate avoiding momentary surface heating that is too high for practical fiber draw speeds given a laser beam with sufficient energy to heat the optical fiber to the desired degree. Furthermore, in some embodiments, greater lengths of optical fiber can be illuminated (irradiated) with the light at any given time. It should also be understood that, while not shown in FIG. 3A, some embodiments include collimation lenses and various beam expanding or beam conditioning optics and the like to control laser beam characteristics. Such additional optical components, can, thus, form part of a light director configured to direct light from the light source to the optical fiber on the fiber draw.

FIG. 3B illustrates a cross-section of a high-aspect-ratio light beam. The light beam can be, for example, the laser light beam represented by the light rays 344 in FIG. 3A after reflection from the parabolic mirrors 346. The contour lines 336a, 336b, and 336c represent locations of equal intensity in a cross-section of the light beam. As illustrated in FIG. 3B, the width W of the beam is significantly greater than the height H of the beam, and the aspect ratio is defined by W divided by H. In embodiments that include combined multiple beams with smaller aspect ratios, as described above, an aspect ratio can be defined for each of the multiple beams.

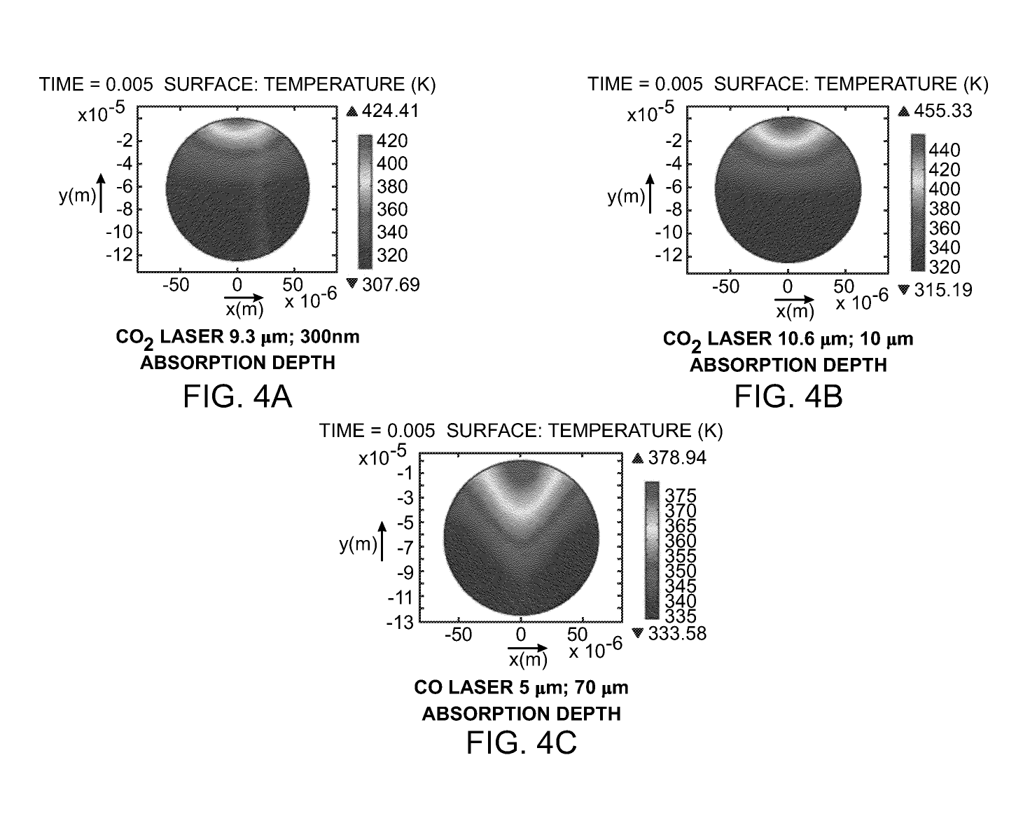

FIGS. 4A-4C illustrate the effect of light source wavelength on fiber heating uniformity, assuming heating from only one side of the fiber (irradiating the fiber radially non-symmetrically with the light). FIGS. 4A-4C illustrate data from simulations of laser heating of fiber using wavelengths from CO₂ and CO lasers operating at various respective wavelengths. Specifically, the simulations consider a 2D Gaussian beam, with peak intensity of 10 MW/m² focused to a 60 micron spot size at the apex of the circular cross-section of the fiber. In general, various laser wavelengths in the infrared region can be used for heating the fiber. In particular, an infrared wavelength range from about 3.5 microns to about 11 microns is useful because these wavelengths are absorbed more strongly by silica fiber.

FIG. 4A is a cross-sectional temperature profile of an optical fiber after 5 milliseconds (ms) of heating using a CO₂ laser operating at 9.3 microns. The absorption depth of the optical fiber at this wavelength is 300 nm. As indicated in FIG. 4A, after 5 ms of heating time, the temperature across the cross-section of the fiber ranges from about 320K to about 420K, or a range of about 100K.

FIG. 4B also illustrates heating at 5 ms, but with the CO₂ laser operating at a wavelength of 10.6 microns. The absorption depth for this wavelength is 10 microns, and the temperature over the cross-section ranges from about 320K to about 440K, or about 120K. Note that, even though the absorption depth of the laser light is greater at 10.6 microns, the surface-to-interior temperature difference is greater. This is because the reflection at normal incidence from the surface of the glass at 10.6 microns is 15%, while that at 9.3 microns is 40%. This represents a deviation from the general rule that greater absorption depth yields lower temperature gradients. It is a secondary effect, however, as will be further described hereinafter.

In FIG. 4C, the fiber heater is a CO laser operating at 5 microns, and the absorption depth for this wavelength is 70 microns. As can be seen in FIG. 4C, after 5 ms of heating, the temperature is much more uniform, than in FIG. 4A or 4B, covering a range of only about 40K over the cross-section in FIG. 4C. Thus, as illustrated in FIGS. 4A-4C, heating silica fiber with a laser wavelength having greater absorption depth results in more uniform temperature distribution across the fiber's cross-section. Note, however, that the laser also preferably deposits nearly its full energy into the glass, instead of light passing through the glass with minimal absorption. Otherwise, the ability to reheat can be compromised. Hence, if this strategy is used to minimize the momentary, transient temperature difference between the skin (surface) and the core of the fiber, then it is preferable to not use a wavelength that has an absorption depth significantly greater than the thickness of the fiber. (For standard optical fiber used for communications, this diameter would be 125 microns.)

FIGS. 5A-5D illustrate temperature uniformity benefits of heating the silica fiber 108 from multiple directions. FIG. 5A is a schematic illustration of conditions for the simulations illustrated in FIGS. 5B-5D. In particular, a directed light source and a light director are assumed to illuminate the fiber 108 with light 104 from four different radial directions around the fiber. As illustrated in FIG. 5B, for the CO₂ laser at 9.3 microns, with absorption depth of 300 nm, after 5 ms of heating, the temperature across the cross-section of the optical fiber varies by only about 20K. This 20K variation is in contrast with the 100K variation seen in FIG. 4A for the same laser wavelength but only one direction of incident light.

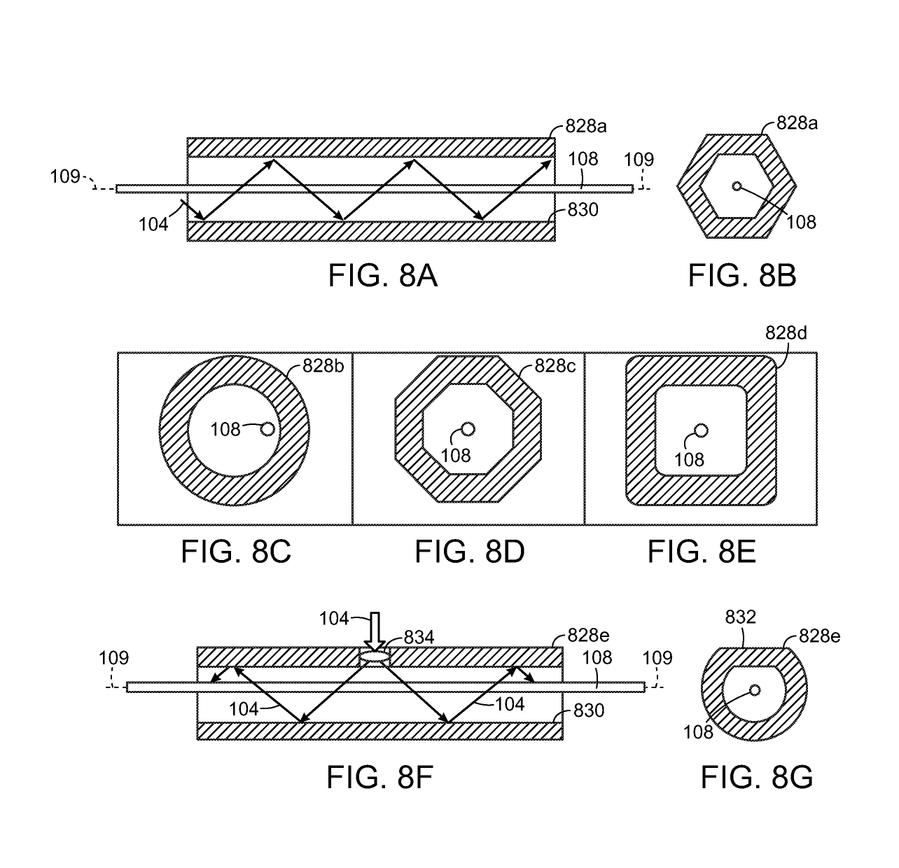

FIG. 5C shows a simulation for the case of the CO₂ laser at 10.6 microns heating the optical fiber from four different directions. In this case, the temperature over the cross-section of the fiber is uniform to within about 25K, compared with the 120K range seen in FIG. 4B. FIG. 5D illustrates the simulation for the CO laser operating at 5 microns, with 70 microns absorption depth. In this case, the temperature variation across the cross-section of the fiber is only about 7K, compared with the 40K range seen in FIG. 4C. Thus, the simulations illustrated in FIGS. 5B-5D, compared with the simulation illustrated in FIGS. 4A-4C, show that heating with four lasers or split laser beams from different directions (causing directed light to intersect the optical fiber from more than one radial direction around the fiber) results in much greater temperature uniformity than the case of using a single direction of illumination. The diagram in FIG. 5A illustrates this principle for radial directions around the optical fiber. Embodiments described hereinafter in relation to FIGS. 7C-7D and 8A-8G, for example, illustrate other embodiments that can be used to cause light to intersect the optical fiber from more than one direction to increase temperature uniformity. While embodiments of the invention do not require heating an optical fiber from multiple directions, doing so is one of a number of techniques by which one can avoid melting the surface or cladding of the fiber, even while rapidly heating the core of the fiber to within the glass transformation temperature range. This and other techniques will be further described in reference to FIG. 10.

FIGS. 6A-6C illustrate further cross-sectional uniformity benefits that can be achieved by pulsed (interrupted) heating. Over time, pulsed or interrupted heating increases temperature uniformity in a given cross-section of the fiber via diffusion. Such pulsed or interrupted heating can be achieved with, for example, a pulsed laser source or a laser source coupled to an optical chopper or a laser source that is otherwise shuttered intermittently. Such pulsed heating is one way in which the transient fiber cladding temperature can be maintained to within 500° C., for example, of the transient fiber core temperature. Furthermore, the transient fiber cladding temperature can be maintained to within 400° C., 300° C., 200° C., or 100° C. of the transient fiber core temperature during heating with “off” intervals of sufficient length.

FIG. 6A is a graph showing transient fiber cladding and transient fiber core temperatures over time during heating when the heating from the four directions illustrated in FIG. 5A is assumed to occur at intervals. During the period from 0 ms to about 5 ms, one example period when laser heating is occurring, the transient cladding temperature differs from the transient core temperature. Another such heating period occurs starting at 20 ms. For example, at time 25 ms, FIG. 6B shows that the cross-sectional fiber temperature varies by about 20K. However, during a subsequent period when there is no heating (e.g., at 50 ms, as illustrated in FIG. 6C), the fiber cladding and core temperatures become substantially equal, with a variation of only about 0.1K. Again, this and other techniques are further described hereinafter in relation to FIG. 10.

FIGS. 7A-7C are schematic illustrations of various optical layouts that can achieve desirable temperature profiles along an axis 109 of the optical fiber 108. In FIG. 7A, a laser beam 104 is split by partial reflective mirrors 748a and 748b into multiple beams directed toward the fiber 108 and various positions to intersect a plurality of respective segments 749a-c of the fiber. By using particular mirror reflectivities, the beam 104 can be divided appropriately to produce desired intensities at each position along the fiber. For example, for the series of three beam splitters 748a-c in FIG. 7A, the reflectivity of beam splitter 748a can be 33% and the reflectivity of the second beam splitter 748b can be 50%, and the reflectivity of the final beam splitter 748c can be 100% to produce approximately equal intensity beams from each of the three beam splitters to propagate toward the fiber. Adjacent to each beam splitter 748a-c is a compound optical lens 750 that causes the beam to diverge with a high aspect ratio toward the fiber 108. In other embodiments, desired intensities at each position along the fiber are different, and reflectivities of the beam splitters are accordingly adjusted as needed. Thus, in the embodiment of FIG. 7A, the directed light 104 is beam split into a plurality of split beams. Simultaneously, each of the split beams is beam expanded to intersect a respective segment of the optical fiber 108.

While the embodiment of FIG. 7A includes beam splitters and lenses to direct light to only one side of the fiber 108, other embodiments include further combinations of beam splitters and lenses to direct light towards the optical fiber 108 from the opposite direction. Furthermore, still other embodiments include directing beams toward the optical fiber from four or more directions, as illustrated in FIG. 5A, to achieve the further radial temperature uniformity benefits illustrated in FIGS. 5B-5D. Moreover, the series of three beam splitters and three lenses can be replaced by a series of any number of beam splitter/lens combinations necessary to heat various lengths of optical fiber. Furthermore, in some embodiments, high-aspect-ratio lenses are not required, as illustrated in FIGS. 7B-7C.

FIG. 7B is a schematic diagram illustrating an alternative optical layout that can also achieve various temperature profiles along the axial direction 109 of the fiber, even without requiring the lenses 750 of FIG. 7A or other beam shaping elements. In contrast to FIG. 7A, the embodiment of FIG. 7B omits the lenses 750 but includes rotatable scanning beam splitters 752a-c. The rotatable beam splitters can rotate to illuminate the fiber 108 to direct the light to various axial locations along the fiber, actively scanning the beam of light 104 along the axis 109. The beam splitters can be scanned using galvanometer motors or other actuators (not shown) known in the art, for example.

FIG. 7C is a schematic diagram illustrating an embodiment similar to that of FIG. 7B. However, the embodiment in FIG. 7C also includes a parabolic reflector mirror 754 oriented such that the fiber 108 is drawn through a focal line of the parabolic mirror. Directed light 104 is directed toward the parabolic reflector mirror 754. While some of the light 104 is absorbed by the fiber on the first pass, most of the light 104 continues on and is reflected by the mirror 754. This embodiment has the advantage that light 104 not initially absorbed by the fiber 108 on the first pass can be reflected back towards the fiber to illuminate the fiber from a different direction. FIG. 7D is a schematic diagram illustrating an end view cross-section of the fiber 108 and parabolic mirror 754 illustrated in FIG. 7C.

Cooling rate can also be controlled by adjusting laser power in one or more segments of a light-based optical fiber heater corresponding to segments 749a-c of the light-based optical fiber heater. For example, in FIG. 7A, if the beam splitters 748a and 748b have sufficiently high reflectivities, then the power applied to the fiber segment 749c can be low enough to not further heat the fiber, yet still high enough to slow fiber cooling. Thus, in some embodiments, a light-based fiber heater, or a segment thereof, can be used to control cooling rate within the glass transformation temperature range to extend cooling time.

FIG. 7E illustrates several example temperature profiles that can be achieved using the embodiment systems illustrated in FIGS. 7A-7D, for example. Each temperature profile shows fiber temperature (arbitrary units) as a function of fiber axial position (arbitrary units). The profile 756a is a slow ramp up profile. The profile 756b is a fast ramp up profile, followed by a slow cool down time period. The profile 756c features a fast temperature ramp up, fast temperature cool down, and a flat top profile in the middle. The profile 756c is one example profile having a rapid cooling region (on the right side of the profile) that can lead to compressive stress at the fiber surface. Moreover, embodiments can provide multiple reheating and cooling cycles over the length of the fiber (equivalent to time in the case of a moving fiber), as illustrated in profiles 756d-f. The temperature profile can be altered over time, for example, by changing from slow ramp up to slow cool down in several seconds or a longer time period. For each of the profiles in FIG. 7E, a maximum temperature in the profile, a flat top of the temperature profile (e.g., in profile 756c), or a slower cooling or slower heating segment of the optical fiber can be within the glass transformation temperature range of the fiber core, for example. Thus, the light-based optical fiber heaters of FIGS. 7A-7D, for example, can not only heat a fiber core to the glass transformation temperature range of the fiber core, but also maintain the fiber core within the glass transformation temperature range for a desired time period to achieve the benefits described hereinabove.

In addition to achieving rapid reheating within a small fiber span at high draw speeds, the embodiments of FIGS. 7A-7D can be used to increase temperature of the fiber core up to around 1500° C. or a lower temperature, for example. As already described herein, multiple benefits can be realized when the fiber core is heated to a temperature within the glass transformation temperature range, followed by relatively slow cooling. Very slow cooling can be achieved by using vacuum assisted cooling strategies, for example, to result in fiber with lower fictive temperature than if cooled at room temperature, leading to ultra-low attenuation losses.

FIGS. 8A-8G illustrate that the light director 106 in FIG. 1A can also include a hollow waveguide. For example, FIG. 8A illustrates a waveguide 828a with an interior high-reflectivity surface 830 that has a hexagonal cross-sectional profile. In some embodiments, the high-reflective surface contains a metal coating. In some embodiments, the high-reflective surface is formed by using multiple reflective dielectric layers, for example periodic high and low index Bragg layers. The optical fiber 108 is drawn through the waveguide 828a, and light 104 is introduced into an end of the waveguide and allowed to propagate between reflective surfaces and be absorbed by the fiber 108. A portion of the laser energy is absorbed by the optical fiber 108 each time the laser beam overlaps with the fiber during the propagation along the axial direction and between reflective sides of the waveguide. This can result in substantially uniform axial heating over a length of fiber if desired. The embodiment of FIG. 8A, similar to other waveguide embodiments illustrated in FIGS. 8C-8G, for example, have the advantage of reducing or eliminating multiple optical components such as mirrors and lenses, reducing any need for optical alignments, and eliminating active beam scanning. One advantage of the waveguide based optics is that they can allow most laser power to be absorbed by the fiber. Thus, waveguides can be a very efficient approach. However, in some cases, waveguides can be damaged at high power, and care must be taken to avoid damaging power for a given waveguide. FIG. 8B is a radial cross-sectional view of the hexagonal waveguide 828a and fiber 108 illustrated in FIG. 8A.

FIGS. 8C-8E illustrate that waveguide geometries are not limited to the hexagonal structure illustrated in FIGS. 8A-8B. For example, in FIG. 8C, a waveguide 828b has a circular interior cross-section, while in FIG. 8D, the waveguide 828c has an octagonal interior cross-section. Furthermore, FIG. 8E illustrates the waveguide 828d with a substantially square interior cross-section having rounded corners. A wide variety of interior cross-sectional profiles can be used, including curved interior profiles, various polygonal profiles, circular profiles, elliptical profiles, D-shaped profiles, etc. If the hollow waveguide has a symmetry with respect to a central axis, preferably, the optical fiber 108 is drawn off the center of the hollow interior of a waveguide to increase the overlap between the fiber and light beam. For example, in FIG. 8C, the optical fiber 108 is off center with respect to the cylindrical interior waveguide surface having the circular cross-section.

These hollow waveguide structures can be formed, for example, using a mechanical drawing process similar to a fiber drawing process. Alternatively, the hollow waveguides can be constructed with several pieces of precision machined parts. For example, a circular waveguide such as that illustrated in FIG. 8C can be assembled with two or three pieces of curved parts. It is preferable that interior surfaces of the waveguides be polished to mitigate scattering losses.

FIG. 8F illustrates that light need not be introduced to a hollow waveguide through an end port. In FIG. 8F, light 104 is introduced into the hollow waveguide 828e having a substantially cylindrical interior reflective surface. The light 104 is introduced into the hollow waveguide through a beam shaping element 834 that is highly divergent and launches the light into the waveguide in both axial directions. FIG. 8G is a cross-sectional illustration of the hollow waveguide and fiber illustrated in FIG. 8F. While the interior and exterior surfaces of the waveguide 828e are substantially cylindrical, the waveguide 828e includes a flat section 832 that houses the divergent beam shaping element 834. In other embodiments, a beam shaping element can be used without the flat section 832. Moreover, in alternative embodiments not shown, instead of only a single beam shaping element 834, there are multiple beam shaping elements located at different positions along the length of the waveguide. In these alternative embodiments, the multiple beam shaping elements are positioned at different openings for heating the fiber at different locations along the fiber axis 109. Furthermore, in yet other embodiments, multiple waveguides can be used to heat or control cooling in various segments of the optical fiber to achieve a greater variety of temperature profiles such as those illustrated in FIG. 7E.

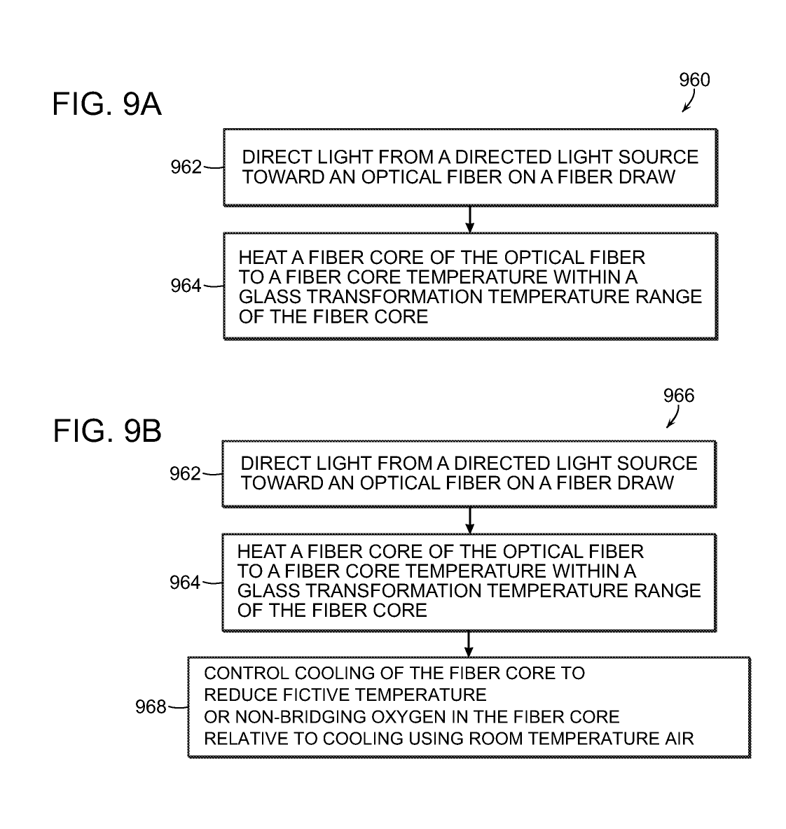

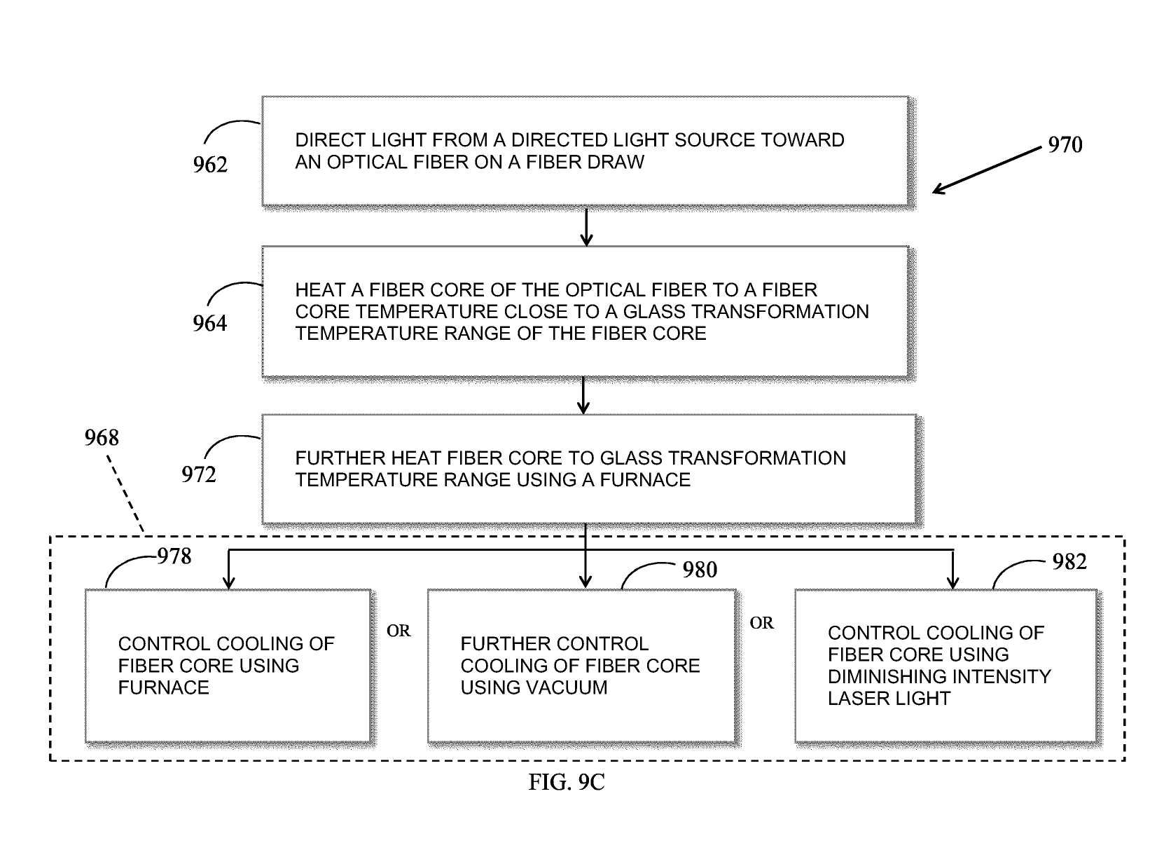

FIG. 9A is a flow diagram illustrating an embodiment method 960 of processing optical fiber. At 962, light is directed from a directed light source toward an optical fiber on a fiber draw. At 964, a fiber core of the optical fiber is heated, using at least the light from the directed light source, to the fiber core temperature within a glass transformation temperature range of the fiber core. The fiber core temperature can be any temperature within the glass transformation temperature range 118 illustrated in FIG. 1B, for example, including a fictive temperature such as T_{Fslow cooling} or T_{Ffast cooling}.

FIG. 9B is a flow diagram illustrating an alternative method 966 of processing optical fiber. Following directing the light at 962 and heating the fiber core at 964, the fiber core cooling is controlled, at 968, to reduce fictive temperature or non-bridging oxygen in the fiber core relative to cooling using room temperature air. Consequently, Rayleigh scattering may also be reduced. In various embodiments, cooling of the fiber core can be controlled using light-based optical fiber heaters such as those illustrated in FIGS. 3A and 7A-7D. Furthermore, in some embodiments, cooling is controlled using a light-based optical fiber heater including a hollow waveguide, such as those illustrated in FIGS. 8A-8G. However, in other embodiments, such as that illustrated in FIG. 9C, cooling of the fiber can be controlled using a furnace or vacuum system, for example.

FIG. 9C is a flow diagram illustrating an alternative embodiment method 970 for reheating processing optical fiber. After directing the light at 962, the fiber core of the optical fiber is reheated. In particular, the method 970 of processing includes two fiber reheating steps. First, at 964, the fiber core is reheated to a temperature close to the glass transformation temperature range of the fiber core. Using the light-based optical fiber heater to heat only close to the glass transformation temperature range, in contrast to all the way to the transformation range, includes the benefit of heating the optical fiber quickly over a short distance while avoiding any accidental overheating or melting of the fiber. Subsequently, at 972, the fiber core is further heated all the way to the glass transformation temperature range using a furnace, which heats the fiber substantially more slowly, as previously described hereinabove, but with much greater precision as to the final temperature.

FIG. 9C also shows more explicitly how a function 978 (controlled cooling of the fiber) may be accomplished. Specifically, in one embodiment, cooling is controlled 978 via running the fiber in a vacuum. In another embodiment, at 980, cooling may be controlled by running the fiber in a furnace for which the thermal radiation temperature is much higher than ambient although lower than the fiber temperature. In yet another embodiment, at 982, the fiber cooling is controlled by continuing to irradiate the fiber with a diminishing intensity directed light source. In still further embodiments not illustrated, a combination or subcombination of elements 978, 980, and 982 may be used.

FIG. 10 is a graph showing surface (skin) temperature and core temperature of a fiber as the core is being reheated from 600° C. to 1250° C., the latter being a useful temperature for further processing of the core, using beamwidths of 100 mm, 200 mm, and 500 mm respectively, where beamwidth is defined as shown in FIG. 3B. The graph was produced using a laser heating model in which the fiber is moving at 60 m/s. (Note that this high speed illustrates a particularly stringent case in terms of the difficulty of reheating.) The laser used for the model is a CO₂ laser with a power of 4 kW, and beam directing optics create two beams, each approaching the fiber at the same elevation but from opposite (180 degrees) directions. At the intersection of the beam with the fiber surface, the two beams have a (cross-section profile) height (illustrated in FIG. 3B) of 250 microns.

The 100 mm beam width in FIG. 10 shows the issue with momentary overheating at the surface. Specifically, the maximum azimuthal surface temperature is 1850° C., which is clearly well above the melting point of the glass. (The melting point, which can alternatively be described as the softening point, for fused silica is approximately 1700° C. for fused silica.) For the 200 mm beam width, the fiber core reheats to the same useful temperature, but the maximum surface temperature is 1500° C., which is below the melting point.

For the 500 mm beam width in FIG. 10, again, the fiber core reheats to the same useful temperature, while the maximum surface temperature hardly overshoots the fiber core temperature. The beam width threshold and corresponding aspect ratio above which the fiber core attains the desired temperature while avoiding melting at the fiber surface will vary with situation specifics. This particular model assumed a very high fiber draw speed, thus exacerbating the challenge of heating the fiber core sufficiently while not overheating the fiber surface. In general, though, for given beam powers and fiber speeds, increasing beam width (and, thus, increasing aspect ratio assuming fixed beam height) is a method by which one can reduce momentary overheating of the fiber surface and, in particular, avoid surface melting.

As described hereinabove in this disclosure, while reheating the fiber core to a temperature that is useful for further processing, it is desirable to avoid the side effect of melting the fiber surface. Summarized hereafter are some ways to avoid the side effect of melting, as follows.

(i) The fiber can be irradiated with a wavelength that has greater absorption depth (while taking reflectivity into account), as illustrated in FIGS. 4A-4C, for example.

(ii) The fiber can be irradiated from more than one direction, thus reducing azimuthal hot spots, as illustrated in FIGS. 5A-5D, for example.

(iii) The fiber can be heated in steps, with time between steps to allow surface-to-core temperature gradients to subside, as illustrated in FIGS. 6A-6C, for example.

(iv) The beam or beams can be scanned along the axis of the fiber, as illustrated in FIGS. 7B-7C, for example.

(v) The fiber can be irradiated by a sufficiently wide, non-scanning beam of high aspect ratio, for example. Effects of such beams are illustrated by way of example in FIG. 10.

Each of the above example methods may be used alone, or in any combination, to avoid momentary overheating and possible melting of the fiber surface.

In addition to the methods described above, another way of avoiding overheating and possibly melting the fiber surface lies in the fiber itself. If the fiber is already well above room temperature, then the amount of additional energy necessary to bring the fiber core to a desired temperature is reduced. To illustrate this point, considering FIG. 10, if the fiber entering the reheating apparatus had been room temperature (20° C.) instead of 600° C., then, given the same laser and fiber speed, to heat the core to the same 1250° C. using a 100 mm beam width would result in a maximum azimuthal fiber skin temperature of 2600° C. This is not only well above the melting point of the fused silica, but it is in fact so hot that sublimation of the fused silica in the form of SiO₂ or SiO would be extremely rapid. Thus, the closer the fiber core and cladding already are to the desired temperature, the easier it is to reheat them to the desired temperature and the easier it is to avoid momentarily overheating the fiber surface and possibly melting the fiber surface. In general, it is desirable for the fiber to enter the reheating step with core and cladding temperature already greater than 200° C., or greater than 400° C., 600° C., 800° C., or 1000° C., for example, assist in avoiding overheating the fiber surface or cladding.

Finally, it should be noted that, while it is desirable to avoid fiber surface melting, it is not absolutely necessary to avoid it. Hence, the reheating methods that have been described in this application could be used without the above additional techniques for avoiding surface melting.

While this invention has been particularly shown and described with references to example embodiments thereof, it will be understood by those skilled in the art that various changes in form and details may be made therein without departing from the scope of the invention encompassed by the appended claims.

What is claimed is:

1. A method of processing optical fiber, the method comprising:
directing light from a directed light source toward an optical fiber on a fiber draw; and
heating a fiber core of the optical fiber, using at least the light from the directed light source, to a fiber core temperature within a glass transformation temperature range of the fiber core.

2. The method of claim 1, wherein the heating the fiber core is performed without melting the fiber core or a fiber cladding around the fiber core.

3. The method of claim 1, wherein the heating the fiber core includes maintaining the transient fiber cladding temperature to within 300° C. of the transient fiber core temperature.

4. The method of claim 1, wherein the directing light from the directed light source includes using a light wavelength for which an absorption depth of the optical fiber is greater than about 10 microns and less than or equal to the diameter of the uncoated fiber.

5. The method of claim 1, wherein the directing light toward the optical fiber includes causing the light to intersect the optical fiber from more than one direction around the fiber.

6. The method of claim 1, wherein the directing light includes using a pulsed directed light source.

7. The method of claim 1, wherein the directing light includes illuminating with the light, at any given time, a length of the optical fiber greater than or equal to about 1 centimeter

8. The method of claim 1, wherein the heating the fiber core includes reheating the drawn fiber before allowing the fiber core to cool to below 600° C.

9. The method of claim 1, wherein the directing the light includes actively scanning a beam of the light along an axis of the optical fiber.

10. The method of claim 1, wherein the directing the light includes beam splitting the light into a plurality of split beams and simultaneously beam expanding the split beams to intersect a plurality of respective segments of the optical fiber.

11. The method of claim 1, wherein the directing the light includes reflecting the light using a parabolic reflector, the optical fiber drawn through a focal line of the parabolic reflector.

12. A system for processing optical fiber, the system comprising:
a light-based optical fiber heater including:
(i) a directed light source; and
(ii) a light director configured to direct light from the light source to an optical fiber on a fiber draw,
the fiber heater configured to heat a fiber core of the optical fiber to a fiber core temperature within a glass transformation temperature range of the fiber core.

13. The system of claim 12, wherein the light-based optical fiber heater is further configured to heat the fiber core without melting the fiber core or a fiber cladding around the fiber core.

14. The system of claim 13, wherein the light-based optical fiber heater is further configured to maintain the transient fiber cladding temperature to within 300° C. of the transient fiber core temperature.

15. The system of claim 12, wherein the directed light source is configured to output a light wavelength for which an absorption depth of the optical fiber is greater than about 10 microns and less than or equal to about the diameter of the uncoated fiber.

16. The system of claim 12, wherein the light director is further configured to cause the light to intersect the optical fiber from more than one direction around the fiber.

17. The system of claim 12, wherein the directed light source is a pulsed directed light source.

18. The system of claim 12, wherein the light director is configured to direct the light, at any given time, over a length of the optical fiber greater than or equal to about 1 centimeter

19. The system of claim 18, wherein the light-based optical fiber heater is further configured to reheat the drawn fiber before allowing the fiber core to cool to below 600° C.

20. The system of claim 12, wherein the light director includes an active scanner configured to scan a beam of the light along an axis of the optical fiber.

21. The system of claim 12, wherein the light director includes a plurality of beam splitters configured to provide a plurality of split beams and a plurality of respective beam expanders configured to simultaneously cause the respective split beams to intersect the optical fiber at a plurality of respective segments of the optical fiber.

22. The system of claim 12, wherein the light director includes a parabolic reflector configured to focus the light toward a focal line of the parabolic reflector through which the optical fiber is drawn.

23. The system of claim 12, wherein the directed light source includes an LED, CO₂ laser, CO laser, quantum cascade (QC) laser, pulsed laser, continuous wave (cw) laser, or ultraviolet (UV) light source.
